(19) United States
(12) Patent Application Publication
(10) Pub. No.: US 2026/0065271 A1
(43) Pub. Date: Mar. 5, 2026

(54) SERVER-ENFORCED ACTIVATION OF CONDITIONAL DIGITAL ENTITLEMENTS VIA FRESHNESS-BOUNDED VERIFICATION AND AUDIT-COUPLED COMMIT PATHS

(71) Applicant: Joseph Patrick Lundquist, Volente, TX (US)

(72) Inventor: Joseph Patrick Lundquist, Volente, TX (US)

(21) Appl. No.: 19/312,288

(22) Filed: Aug. 27, 2025

Related U.S. Application Data
(60) Provisional application No. 63/870,855, filed on Aug. 26, 2025.

(51) Int. Cl. G06Q 20/40; G06F 21/62

(52) U.S. Cl. CPC G06Q 20/401; G06F 21/62

(57) ABSTRACT

A computer-security architecture removes activation authority from client-facing purchase flows. A server records a digital entitlement in an INACTIVE state and issues a presentation artifact. A verification service accepts messages only from trusted origins carrying freshness-bounded evidence and validates using (i) stateless keyed recomputation over a time-windowed payload, (ii) confirmation that token-rail authorization data maps to a registered association within a policy freshness bound, or (iii) a server-maintained session. Activation occurs only on an authoritative commit path that enforces no activation without a durable audit record and effective-once behavior: either a single ACID transaction that conditionally updates state and writes an insert-only audit in the same commit, or an append-only activation ledger with idempotent materialization. Access controls deny issuance-facing code permission to set ACTIVE. Expiration is timer-free via batch or TTL evaluation.

### CROSS-REFERENCE TO RELATED APPLICATIONS

This application claims the benefit of U.S. Provisional Patent Applications 63/687,770 filed Aug. 27, 2024; 63/688,300 filed Aug. 28, 2024; 63/688,851 filed Aug. 29, 2024; 63/694,179 filed Sep. 12, 2024; 63/703,199 filed Oct. 3, 2024; 63/708,736 filed Oct. 17, 2024; 63/760,618 filed Feb. 19, 2025; 63/778,378 filed Mar. 26, 2025; 63/781,989 filed Apr. 1, 2025; 63/791,288 filed Apr. 18, 2025; 63/802,560 filed May 8, 2025; 63/821,373 filed Jun. 10, 2025; 63/830,445 filed Jun. 25, 2025; 63/837,112 filed Jul. 1, 2025; 63/854,406 filed Jul. 30, 2025; 63/859,103 filed Aug. 6, 2025; 63/860,630 filed Aug. 8, 2025; 63/864,284 filed on Aug. 14, 2025; and 63/870,855, filed on Aug. 26, 2025. The disclosure of each is hereby incorporated herein by reference in its entirety.

### FIELD OF THE INVENTION

This disclosure relates to computer security for digital-entitlement lifecycle control. In particular, it concerns systems that decouple issuance from activation and that perform activation only through an authenticated, freshness-bounded verification executed on a server-side authoritative commit path that durably records an audit artifact and enforces exactly-once semantics.

### BACKGROUND OF THE INVENTION

Conventional computer systems for issuing digital assets suffer from a fundamental architectural flaw: instant finality. In these systems, a successful purchase transaction results in the immediate issuance of a digital asset in its final, usable state; coupling issuance and activation into one step, making abuse primarily a race at the edge. This architecture concentrates the security risk at a single, vulnerable point—the online purchase interface—which is susceptible to exploitation by automated software agents (“bots”).

Existing defenses, such as CAPTCHAs and rate limits, attempt to detect and block bots at this interface. However, these client-side, detection-based approaches are locked in an arms race against increasingly sophisticated automation, which can emulate human behavior and operate from distributed networks to circumvent such defenses.

These technical failures stem from architectural limitations: synchronous validation creates bottlenecks susceptible to distributed denial-of-service, client-side state management enables replay attacks, and the lack of cryptographic binding between issuance and activation enables replay/impersonation of activation operations; server-side commit paths mitigate this risk. The concentration of both issuance and activation logic in a single service endpoint creates a critical failure point that amplifies these vulnerabilities. The technical problem is therefore not merely the difficulty of bot detection, but the inherent vulnerability of an architecture that grants full utility to an asset at the moment of a purely digital, and thus emulatable, transaction.

There is a need for a practical architecture that (i) issues assets in a non-functional state; (ii) requires an authenticated, replay-resistant verification event, preferably tied to real-world presentation; and (iii) enforces activation via atomic, auditable state transitions with scalable, timer-free expiration.

Conventional issuance confers immediate utility: completion of an online purchase results in a final, usable ticket or capability. This coupling of purchase and utility concentrates attack surface at the purchase interface and enables automated acquisition at scale.

In contrast, the disclosed architecture issues a conditional entitlement—an enforceable right recorded as a non-functional asset—rather than a final ticket or capability. The entitlement becomes usable only upon satisfaction of a server-verified activation policy executed by a verification service, such as presenting a device-resident artifact at a trusted origin within a time window. The decisive state change is removed from the purchase interface and executed in a protected pathway with durable auditability.

### SUMMARY OF THE INVENTION

The disclosure provides a computer-security architecture that decouples issuance from activation and removes activation authority from client-facing purchase flows. Activation occurs only on a server-side authoritative commit path that, in a single atomic action, updates state and writes an insert-only audit artifact, or appends an activation event to an append-only ledger with idempotent materialization. Validation may use freshness-bounded evidence from trusted origins and does not have to rely on a client purchase session.

The orchestrator validates by one or more of: (i) recomputing a keyed authentication value (e.g., HMAC) over a credential payload {asset_id, window_id, policy_tag, KID} and accepting only if window_id falls within a policy tolerance; (ii) verifying that data produced by presentation of a tokenized identifier maps to a registered association and that a trusted event time satisfies server_time-trusted_event_time<=DELTA_POLICY, where trusted_event_time is a relay-signed receipt time or an endpoint-signed event time verified under policy; or (iii) correlating a server-maintained verification session by matching a server-issued challenge with step-up responses (e.g., WebAuthn, device-integrity attestations) under rolling nonces and server-side replay protection. The orchestrator also enforces endpoint policy (e.g., class or location binding), per-endpoint rate limits, and per-asset attempt thresholds.

When all checks succeed, a single atomic database transaction updates the asset's state to ACTIVE and appends a durable entry to a durable audit store (insert-only). Assets that do not activate within the policy-defined window are transitioned to an EXPIRED state through periodic batch processing, thereby avoiding the overhead of per-asset timers. The architecture decouples issuance of a conditional entitlement from issuance of the utility artifact or capability, effecting a deterministic substitution only upon an authenticated, audited activation event executed within a single database transaction.

In preferred embodiments, the system sells or grants a conditional entitlement, i.e. a contract right recorded as an INACTIVE asset, rather than a final utility artifact. Activation substitutes the conditional entitlement with a utility artifact or capability only upon receipt of an authenticated, audited verification event committed within a single database transaction. This separation between purchase/issuance and activation/utility is fundamental to the improvement.

This architecture provides specific technical improvements: (1) an authoritative server-side commit path that couples the state change with a durable audit artifact—either a single ACID commit (state update and insert-only audit in the same transaction) or an event-first activation ledger with idempotent materialization; (2) trusted-origin validation with bounded freshness using stateless keyed windows, token-rail evidence, or a server-maintained verification session, without reliance on the client purchase session; (3) access-control gating preventing issuance-facing code from conferring utility; and (4) effective-once semantics under concurrency using uniqueness keys and idempotent processing, together with expiration mechanisms that support timer-free batch/scheduled evaluation and, optionally, per-record TTL semantics under policy.

The system provides a presentation artifact linked to an entitlement. Upon successful verification, the system either (i) changes the entitlement state from INACTIVE to ACTIVE (effectively transforming it into a utility artifact); or (ii) creates, provides, provisions, or transitions to functional, a distinct utility artifact associated with the entitlement while marking the entitlement consumed. The presentation artifact may be the same pass updated to indicate usability or a separate stand-in linked to the utility artifact in the asset state store.

Verification can be single-step (e.g., show up and check in within a time window) or multi-step under a policy-defined activation plan requiring M of N steps, ordered or unordered, with optional dwell-time and deadline constraints. Only plan satisfaction triggers the activation operation.

Durably-coupled activation guarantees (A) no activation occurs without a durable audit record of the activation event and (B) exactly-once processing under concurrency. In preferred embodiments, these invariants are realized by either: (i) a single ACID transaction that conditionally updates state and appends an audit entry in the same commit, or (ii) appending an activation event to an append-only activation ledger with idempotent materialization of the state change or utility artifact and the audit record.

As used herein, durably-coupled activation requires the invariant that (A) no activation occurs absent a durable audit artifact and (B) exactly-once processing is enforced; the invariant is realized either by (i) a single ACID transaction that conditionally updates state and appends an insert-only audit entry in the same commit, or by (ii) an event-first activation ledger that appends an activation event under a uniqueness key and permits only idempotent consumers to materialize state change or utility-artifact creation in causal association with that event, with the audit recorded in the same authoritative write path.

### BRIEF DESCRIPTION OF THE DRAWINGS

FIG. 1A is a system-context and trust-boundary diagram depicting issuance of an INACTIVE entitlement by a primary asset service (110) to an asset state store (120); issuance of a presentation artifact (400) to a client device (300) or wallet/application (310) and secure component (320); verification message origination from trusted origins including a registered verification endpoint (200), an authenticated relay with provenance metadata (225, 228), or an authenticated client over secure transport (330); validation of freshness-bounded evidence using stateless windowed credentials, token-rail artifacts, or a server-maintained session; application of policy and abuse controls (170, 190); and activation executed only by an authoritative commit path-either a single-transaction ACID path (125) that writes state ACTIVE and an insert-only audit (160) or an append-only activation ledger (700)—with a return of the activation result. Only the authoritative path is permitted to write state ACTIVE; issuance-facing code lacks that permission.

FIG. 6 is a flowchart of the authoritative commit path. A verification message (500) is received; origin authentication (510) and one or more validation modes (stateless window, token-rail freshness, or server session) are applied; policy and abuse controls (170, 190) and an optional uniqueness insert (180) guard replays. On the ACID branch (125), the system conditionally updates the asset record in the state store (120) from INACTIVE to ACTIVE (or ACTIVE_PENDING per policy) and, in the same commit, appends an entry to the insert-only durable audit store (160) and updates any presentation artifact record (430). On the ledger branch (700), an activation event is appended under a uniqueness key (705) and idempotently materialized (710) to state and audit; duplicates return the prior result with no state change. Failures roll back without partial effects.

### CANONICAL NUMBERS LIST

System (100)
110 Primary Asset Service (PAS)
120 Asset State Store (DB)
125 Transaction Manager (ACID boundary)
130 State Machine Engine
135 Activation Commit Path (authoritative state+audit)
140 Verification Orchestrator/Service (VO)
150 Cryptographic Module
160 Durable Audit Store (insert only)
170 Policy Store
175 Key Registry (175C Credential, 175R Relay)
180 Processed Verifications (optional uniqueness guard)
190 Rate/Attempt Store
136 Stored Procedure sp_activate (only entry point permitted to write ACTIVE)
Trusted origins (200)
200 Verification Endpoints (trusted origin, umbrella)
210 Physical Verification Terminal (PVT)
215 Credential Accepting Endpoint (CAE)
220 Trusted Software Verification Endpoint (TSV)
225 Integration Service (authenticated relay)
228 Provenance Metadata (origin id, location/class, attestation ref, relay nonce/timestamp)
Client/device (300)
300 Client Device (holder)
310 Wallet/Application
320 Secure Component/Wallet SE
330 Secure Transport (mTLS, etc.)
Credential/presentation (400)
400 Presentation Artifact (credential/pass)
410 Encoder (QR/NFC)
420 Tokenized Identifier
430 Presentation Artifact Record
Verification message (500)
500 Verification Message (VM)
510 Origin Authentication (bearer/transport/signature)
520 Request Identifier/Nonce (jti)
530 Evidence (payload/digest, attested assertion, proximity proof)
540 Timestamp
550 Asset/Record Identifier
555 Origin Endpoint Identifier
565 Endpoint Class
570 Location Indicator
575 Attestation Reference/Device Cert FP
580 Relay Identity
585 Relay Sequence/Event Nonce
590 Freshness Bound DELTA
Fulfillment (600)
600 Fulfillment Service
610 Fulfillment Worker/Job
620 Utility Artifact Store
Ledger path (700)
705 Activation Ledger (append only)
710 Activation Projector (idempotent consumer)

### DETAILED DESCRIPTION OF THE INVENTION

### Architecture

Each service or orchestrator described herein is realized by one or more processors executing instructions stored on non-transitory memory; network interfaces provide the authenticated transports described.

The primary asset service 110 issues digital assets as records in the asset state store 120 under control of a state machine engine 130. A verification orchestrator 140 receives verification messages 500 from verification endpoints 200 either directly over secure transport 330 or indirectly via an integration service 225 that relays authenticated events. The cryptographic module 150 handles keyed authentication for credentials and, in some embodiments, signature verification. A policy store 170 maintains endpoint registry, time-window parameters, location classes, rate limits, and attempt thresholds. A processed-verifications table 180 optionally enforces uniqueness constraints for replay resistance. A durable audit store 160 (insert-only) records state transitions and verification outcomes.

The client device 300 receives an ephemeral credential 400, which the wallet/app 310 renders as a QR/NFC payload via encoder 410, or the credential may be provisioned to a device-resident secure component 320 (e.g., a wallet/secure element).

### 2. Data Structures

### 2.1 Asset Record

An asset record in the state store 120 comprises at least asset_id and state (e.g., INACTIVE, ACTIVE, ACTIVE_PENDING, EXPIRED, REDEEMED, REVOKED). The record may further comprise: (i) timestamps (created_at, optional verify_by, optional expires_at); (ii) an activation policy struct (permitted endpoint classes, optional location class, freshness bound DELTA, and optional release_not_before for timed fulfillment); (iii) optional binding_data (e.g., a privacy-preserving device-fingerprint HMAC computed with a server-held key and an optional per-record salt); (iv) a history_ref pointing to the authoritative audit artifact (an audit entry for the ACID path or a ledger event identifier for the ledger path); and (v) an optional presentation_artifact_ref identifying a row in PresentationArtifact that tracks the lifecycle of any issued presentation artifact. In some embodiments the record also stores a reservation_id to support mint-on-verify issuance.

### 2.2 Ephemeral Credential

The ephemeral credential binds asset_id to a time-window identifier and is verifiable by server-held key material without per-credential storage. The credential payload comprises at least asset_id, window_id, and optionally a policy_tag (e.g., location class), and includes a key identifier (KID) to select validation key material during rotation. A keyed authentication value (e.g., HMAC) over a canonical serialization of the payload allows the server to validate authenticity statelessly.

Canonical serialization. The server serializes [version, asset_id, window_id, policy_tag, KID] using a deterministic binary format (e.g., deterministic CBOR per RFC 8949 § 4.2 with a fixed key set or a fixed-field array). The keyed tag is H=HMAC_SHA256 (K[KID], serialize(payload)), compared in constant time; tag length≥16 bytes.

Window computation and acceptance rule (stateless mode): The server computes window_id=floor((server_time+skew_allowance)/DELTA_WINDOW); the verifier accepts only if the recomputed tag matches and abs (received_window_id-current_window_id)<=tolerance; the verifier rejects future windows (current+1) by default. A boundary grace g<=5 s may be enabled only when the transport is mutually authenticated and the message carries a signature or MAC bound to the endpoint identity; duplication across a boundary is a no-op due to exactly-once processing at activation.

Encodings: The credential may be delivered as (i) a visual or proximity artifact (QR/NFC) carrying the payload and H, or (ii) a device-resident tokenized identifier provisioned to a secure component for token-rail validation.

Multi-format credentialing: A validation endpoint may accept several encodings (e.g., a signed bearer token encapsulating the payload, or a compact code derived from the keyed hash). Each encoding must convey either the full payload or all fields required to recompute H (including asset_id, window_id, policy_tag, and KID); a digest alone is insufficient.

Key rotation: Verifiers maintain a policy-defined set of active KIDs; keys may overlap during rotation windows, after which retired KIDs are rejected.

To avoid timing-channel leakage, keyed authentication values are compared using constant-time equality checks. Keys identified by KID are rotated under a two-window overlap policy to bound acceptance during rotation. The canonical serialization is deterministic (e.g., RFC 8949 determinate CBOR), and the verifier rejects payloads with unknown fields unless the policy explicitly permits them.

### 2.2.1 Presentation Artifact Record

In certain embodiments, a PresentationArtifact row records lifecycle of the presentation instrument: (artifact_id, asset_id, artifact_type, status, activation_event_id, linked_artifact_id, last_seen_at). Upon activation, status transitions to CONSUMED unless policy requires the artifact to remain ACTIVE (e.g., a device-bound payment instrument that continues to exist independently). Where the presentation artifact converts into a utility artifact (e.g., a wallet pass becomes a ticket), linked_artifact_id references the created Utility Artifact.

Client purchase session Verification Message and Authentication: A verification message 500 originating from a verification endpoint 200 contains at least an asset_id 550, an endpoint_id 555, an optional request identifier 520, and a timestamp 540, together with evidence 530 sufficient for credential validation and policy evaluation. The message may be delivered directly to the verification orchestrator 140 over secure transport 330 or indirectly via an authenticated integration service 225 that relays events observed at a credential-accepting endpoint 215. Where a digest is supplied, the message must also include the fields required to recompute the digest and MAC (including asset_id, window_id, policy_tag, and KID), or an encapsulating token from which they are derivable.

The evidence 530 can take one or more of several forms. In some embodiments it includes the credential payload itself or an encapsulating bearer token from which the payload can be recovered; in other embodiments, the evidence includes a digest plus all fields required to recompute the MAC (asset_id, window_id, policy_tag, KID), or an encapsulating token from which they are derivable; a digest alone is insufficient. In still other embodiments, the evidence comprises data produced by presentation of a tokenized identifier at a credential-accepting endpoint-such as a nonce-bearing authorization artifact or approval reference-sufficient for the orchestrator to confirm a registered association with the asset record and to enforce a freshness constraint. The message may further include endpoint metadata (e.g., endpoint class and/or location indicators) that support policy checks stored in the policy store 170. When relayed by the integration service 225, the relay identifies itself and provides provenance information so that the orchestrator can verify that the event originated from an authorized endpoint and was transmitted by an authorized relay.

The verification message is authenticated by at least one of the following categories, which may be used independently or in combination under policy. First, bearer authentication, in which the message carries a bearer credential (for example, a keyed-authentication value over a credential payload or a signed encapsulating token) whose authenticity the server verifies using the cryptographic module 150 without accessing per-credential storage. Second, transport-layer authentication, in which the message is conveyed over a secure channel that authenticates the endpoint and encrypts traffic, such as a client-authenticated connection or an endpoint-scoped credential bound to the endpoint_id. In some embodiments, the message further includes an application-layer digital signature over identified fields (e.g., asset identifier, request identifier, timestamp, and evidence), which the orchestrator verifies using a public key registered for the endpoint. Policy in the policy store 170 defines which authentication assurances are acceptable for a given asset type and may require one or both categories.

Integrator/relay delivery: In some embodiments, a verification message is indirectly delivered to the verification orchestrator by an authenticated integration service 225 that relays events observed at one or more credential-accepting endpoints 215. The relayed verification message includes provenance metadata sufficient to identify an originating verification endpoint, which may comprise one or more of: an originating_endpoint_id; an endpoint class or capability indicator; a site, merchant, or location identifier; a device certificate fingerprint or attestation reference; a relay receipt time; a relay sequence or event nonce; and a digest or reference to the presented credential or authorization artifact. The verification orchestrator authenticates the integration service prior to or as part of validation using one or more mechanisms, such as a mutually authenticated encrypted channel, a message signature or MAC computed with a registered relay key, a signed token (e.g., JWS) bound to a relay key identifier, or an endpoint-scoped API credential over an authenticated transport. A key registry for the integration service (e.g., key identifiers, allowed algorithms, rotation windows, and revocation status) is maintained in the policy store 170. When a relayed message is accepted, the verification orchestrator maps the provenance metadata to a registered originating verification endpoint for policy evaluation (e.g., endpoint class/location checks, rate limits, attempt thresholds). If authentication of the integration service fails, or if the provenance metadata is missing or inconsistent with an entry in the policy store 170, the verification orchestrator rejects the verification attempt. For auditability, the orchestrator records, in the durable audit store 160 (insert-only), the identity of the integration service, a digest of the relayed message, the mapped originating endpoint identity, and the outcome of authentication and policy checks. Freshness evaluation uses a trusted timestamp: the relay's receipt time (signed or MACed) or an endpoint-signed event time within an authenticated skew policy.

Trusted origin including end-user device: A trusted origin for verification includes: (i) a registered verification endpoint authenticated under policy, (ii) an authenticated integration service that relays an event from a registered originating endpoint with provenance, and (iii) an authenticated end-user device operating under a verification policy. The verification message from any trusted origin includes provenance metadata sufficient to bind the event to policy, and evidence with a bounded freshness that demonstrates holder possession and/or presence decoupled from the purchase session.

For high-risk flows, policy may require both mutually-authenticated transport and message-level signature/MAC bound to endpoint_id.

### 2.4 Policy, Rate/Attempt Controls, and Audit

Policy store 170 records endpoint class/location, accepted evidence profiles, allowed windows and tolerances, rate limits, and attempt thresholds. Rate/attempt store 190 maintains counters. Durable audit store 160 is insert-only and records previous/new state, origin identity, time, and a reference to the verification message (or its digest). In the ledger embodiment, any audit table is a projection that references the immutable ledger event identifier; the ledger forbids updates/deletes and may be periodically anchored by a digest for tamper evidence. The consumer processes ledger events within a policy-defined service-level agreement, with failed materializations triggering alerts but not blocking subsequent events. Uniqueness keys and idempotent materialization prevent any second activation for the same asset_id; subsequent events for that asset are rejected or become no-ops until the prior event is materialized.

Freshness is evaluated against a trusted clock (relay receipt time or endpoint-signed event time within an authenticated skew policy). DELTA denotes a freshness bound; DELTA_POLICY is the configured value in the policy store.

Rate/attempt coordination: The rate/attempt store may be centralized or sharded; counters keyed by endpoint_id, asset_id, and optionally holder_id are maintained with atomic increment operations and TTL. Policy defines per-endpoint and per-asset thresholds; endpoint-class limits cap aggregate volume and deter endpoint rotation. Exceeding any limit blocks activation attempts until counters decay.

Integration service policy entries: The policy store 170 may further maintain an integration-service registry comprising: relay identity, allowed origin endpoint sets or endpoint classes, acceptable authentication mechanisms (e.g., mutual TLS profiles, registered signature keys, or MAC keys), permitted algorithms and key identifiers, clock skew/tolerance for relay timestamps, replay-detection parameters (e.g., per-relay event nonces or sequence windows), and revocation state. Policy may require that provenance metadata map to a registered originating endpoint prior to validation and may specify audit fields to be captured for chain-of-custody. Relays must supply per-relay nonces or sequence windows; policy includes anomaly detection thresholds and revocation on misbehavior.

Section 2.5—Device Binding with Subsequent Wallet Provisioning

In some embodiments, device binding is established at the time of asset issuance through device fingerprinting, and the ephemeral credential is subsequently provisioned to a device-resident wallet application. The device fingerprint, computed from device characteristics during the initial purchase interaction, is cryptographically bound to the asset record before wallet pass generation.

The wallet provisioning process creates a device-resident representation of the ephemeral credential but does not alter the underlying device binding. For certain implementations, the system generates a signed pass file containing the credential data and serves it via mobile wallet service endpoints. The wallet application's registration with these endpoints (providing device library identifiers and push tokens) enables real-time pass updates but is distinct from the cryptographic device binding established during asset issuance. The separation of device binding (at issuance) from wallet provisioning (at credential delivery) ensures that the security properties of device binding are established before the credential becomes device-resident, preventing scenarios where wallet pass installation itself could be used to circumvent device consistency requirements.

During verification, the system validates device consistency against the original device fingerprint captured at asset issuance, independent of wallet pass registration status. This approach ensures that verification requires the same device that originally acquired the asset, regardless of subsequent wallet pass management or cross-device synchronization behaviors. Device-binding is advisory and optional, and not meant to be a sole gating factor.

In a privacy-preserving embodiment, device characteristics are minimized and hashed, collected subject to user consent where required, retained for the limited purpose of device-consistency checks, and may be replaced by platform attestation where available. To mitigate re-identification: the fingerprint is computed as an HMAC over selected device attributes using a server-held key (“pepper”) and an optional per-record salt, limiting rainbow-table viability and cross-purchase correlation. Attribute selection favors stable signals (e.g., platform attestation handles OS updates), and the binding may rotate under policy with re-verification. The fingerprint is stored only as the keyed digest; raw attributes are discarded.

### 2.6 Wallet-Rooted Device Binding (Outsourced Binding)

In some embodiments, device binding is provided by a mobile-wallet secure element and an issuer-processor, and the system does not implement its own device-fingerprint binding. The primary asset service associates a pseudonymous instrument identifier (e.g., wallet- or issuer-scoped token or instrument ID) with the entitlement record and treats that association as the binding. Payment-rail authorization events delivered by an authenticated integration service include in-person indicators and terminal/merchant identifiers and refer to the instrument identifier; the verification service accepts such events within a freshness bound DELTA_POLICY as sufficient evidence of holder possession/presence and performs the durably-coupled activation path. This embodiment outsources device binding to the secure element and issuer-processor trust roots, while the system maintains only the entitlement<->instrument association and policy mappings. Examples include, without limitation, issuer processors and wallet platforms that enforce single-device instrument provisioning and furnish normalized authorization data; references to specific vendors are illustrative and not limiting.

In high-risk deployments, policy may require secure-element-rooted binding or platform attestation as a preferred assurance level; however, activation does not require device binding if other verification evidence satisfies policy.

### 3. Flow of Operation

### 3.1 Transaction Path

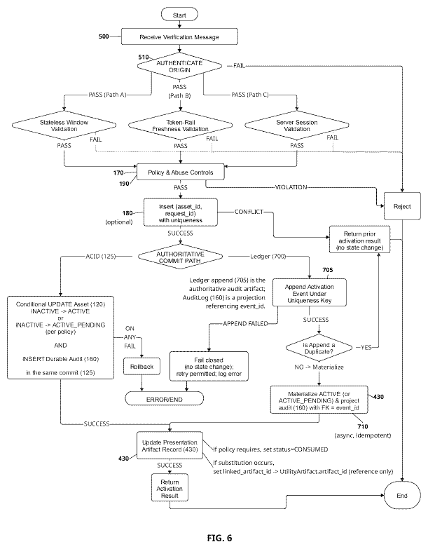

FIG. 6 illustrates an exemplary activation transaction path executed by the verification orchestrator 140 under a single transaction manager 125. The orchestrator optionally inserts (asset_id, request_id) into processed-verifications 180 under a uniqueness constraint; conditionally updates asset state from INACTIVE to ACTIVE only if the prior state equals INACTIVE; and appends an audit entry to durable audit store 160. All operations are performed in a single ACID transaction to prevent partial commits and to ensure that no activation occurs without a durable audit record.
(1) Issuance: Primary asset service 110 inserts an asset with state=INACTIVE and appends an audit record (“created”).
(2) Credential delivery/provisioning: Primary asset service 110 provides an ephemeral credential 400 for QR/NFC rendering by wallet/app 310, or provisions a credential or tokenized identifier to device-resident secure component 320 (e.g., a wallet/secure element) according to policy.
(3) Verification attempt: The holder presents the ephemeral credential to a verification endpoint 200. The endpoint constructs the verification message 500 and transmits it directly to VO 140 or indirectly via integration service 225.
(4) Validation and policy checks (VO 140):
(a) Authentication: validate bearer and/or transport authentication per policy store 170.
(b-stateless) Credential validity (stateless keyed window): recompute a keyed authentication value over P={asset_id, window_id, policy_tag, KID} using server-held key K[KID]; accept only if the recomputed value matches and window_id falls within a policy tolerance. The verifier rejects future windows (current+1) by default. A boundary grace g<=5 s may be enabled only when the transport is mutually authenticated and the message carries a signature or MAC bound to the endpoint identity; duplication across a boundary is a no-op due to exactly-once processing at activation.
(b-token-rail) Token-rail freshness mode: verify that data produced by presentation of a tokenized identifier maps to a registered association and that now( )-evidence.timestamp<=DELTA_POLICY.
(b-session) Server-maintained verification session: correlate a server-issued challenge with one or more step-up responses (e.g., WebAuthn, device-integrity attestations) under rolling nonces and server-side replay protection; accept only if session age<=DELTA_POLICY.
(c) Policy: enforce endpoint class/location binding, per-endpoint rate limits, and per-asset attempt thresholds.
(d) Replay/Idempotency (optional): insert (asset_id, request_id) under a uniqueness constraint; endpoints must supply an unpredictable request_id; on conflict, return the prior activation result and perform no state change.
(5) Authoritative commit path. Activation is valid only if performed on an authoritative commit path that enforces (A) no activation absent a durable audit artifact and (B) exactly-once behavior under concurrency. The path comprises either (i) a single ACID transaction that conditionally updates the asset state and appends an insert-only audit entry in the same commit, or (ii) an event-first activation ledger that appends an activation event under a uniqueness key and authorizes only idempotent consumers to materialize state and an audit projection causally tied to that event. Deployments may use a consistency-preferring substrate (e.g., a primary with synchronous replication or a quorum log) to avoid split-brain; if a network partition prevents the ACID commit or the ledger append, the operation fails closed and is retried. On retry, the uniqueness key and idempotent materialization ensure a single effective activation. In the ledger embodiment, a projector transaction conditionally updates the asset from INACTIVE to ACTIVE (or ACTIVE_PENDING per policy), stores a causal reference activated_event_id to the ledger event_id (705), and writes an audit projection (160) referencing the same event_id; both writes are idempotent.
(6) Result: The asset is usable only when in the ACTIVE state. Upon successful activation, the system may update PresentationArtifact.status to CONSUMED and, where substitution occurs, sets linked_artifact_id to the created Utility Artifact; subsequent reuse returns the prior activation result without state change.

### 3.1.1 Implementations of the Authoritative Commit Path (Non-Limiting).

(i) Single-transaction ACID path. The system executes the following operations within a single atomic transaction:
(1) Uniqueness guard. Insert a record keyed by (asset_id, request_id) into a processed-verifications table; if the key already exists, treat the attempt as a duplicate (no insert).
(2) Conditional state update. Update the asset record to set state=ACTIVE only if the current state equals INACTIVE; if the condition fails, no row is updated (valid no-op for assets already ACTIVE, EXPIRED, REDEEMED, or REVOKED).
(3) Durable audit (success only). If and only if step (2) updated exactly one row, append an entry to an insert-only audit store recording the asset identifier, an activation event type, a provenance digest, a server timestamp, and validation details. If the audit append fails, the transaction is rolled back.

The operations above commit atomically, that is, either the state update and corresponding audit persist together, or neither persists; eliminating TOCTOU races. The transaction structure guarantees that no activation occurs without a durable audit record. On a duplicate uniqueness guard, the transaction performs no state change and writes no new audit entry, and returns the previously committed activation result for the asset. On any storage or constraint error, the transaction rolls back and no writes persist. Database-specific implementations may employ conditional updates, MERGE/UPSERT statements, stored procedures that enforce transactional boundaries, or equivalent atomic constructs. (In ledger deployments, the processed-verifications table is optional; uniqueness is enforced by the ledger append.)

(ii) Event-first ledger path. Append an activation event under a uniqueness key—(asset_id, request_id) for per-attempt deduplication (or, in other embodiments, asset_id for single-winner)-to an append-only activation ledger (e.g., outbox or event log). Only idempotent consumers are authorized to (a) materialize the state change from INACTIVE to ACTIVE (or to ACTIVE_PENDING per policy) and, when substitution is used, mark the entitlement consumed, and/or (b) create a distinct utility artifact while recording an audit projection that references the ledger event identifier. The ledger forbids updates and deletes and may be periodically anchored by a digest for tamper evidence. The append event is the authoritative audit artifact; any audit table row is a projection tied by the event identifier. On a duplicate append, no materialization occurs, no new audit projection is written, and the prior activation result is returned.

Invariants. Both embodiments enforce: (A) no activation without a durable audit artifact; (B) effective-once behavior under concurrency (uniqueness guard/ledger uniqueness plus idempotent processing).

### 3.2 Indirect Delivery Via Integration Service

In certain embodiments, when the verification message is relayed by an integration service 225, the verification orchestrator performs, prior to or as part of credential validation, the following: (a) authenticate the integration service according to the policy store 170; (b) extract and validate provenance metadata and map the message to a registered originating verification endpoint; (c) apply the same policy checks that would apply to a directly connected endpoint, including endpoint class/location, rate limits, and attempt thresholds; and (d) record the relay identity and a provenance digest in the durable audit store 160 (insert-only). Thereafter, the orchestrator performs credential validation using any of the methods disclosed herein (e.g., stateless recomputation of a keyed authentication value and window tolerance, or verification that data from presentation of a tokenized identifier corresponds to a registered association and satisfies a freshness constraint). When a processed-verifications table 180 is enabled, the uniqueness key may include a request identifier derived from the relayed artifact to provide replay resistance across both direct and relayed paths.

For example, a relayed verification flow with authenticated integration service 225 receives a verification event from a credential-accepting endpoint 215, augments the event with provenance metadata 228, and transmits a verification message 500 to the verification orchestrator 140. The orchestrator authenticates the integration service, maps provenance metadata to a registered originating verification endpoint 200 for policy evaluation, and records the relay identity and a provenance digest in durable audit store 160 (insert-only) when the activation transaction commits.

### 3.3 Mint-On-Verify (First Issuance)

In some embodiments, the system records a reservation or mint-right associated with a purchaser and an item selection, without creating any digital asset or ticket at issuance. Upon successful verification, the system performs a first-time creation of the utility artifact (e.g., ticket, capability) and writes a durable audit record in the authoritative commit path. A database uniqueness guard keyed to the reservation or order identifier enforces exactly-once issuance under concurrency. Absent the durable audit record, issuance is invalid. Tie-break/winner semantics: The first authoritative write (ACID commit or ledger append) keyed by (reservation_id, request_id) wins; concurrent attempts return the prior issuance result without duplicating assets. The response includes the artifact identifier and ledger/commit reference of the winning issuance.

### 4. Expiration

Assets may include verify_by and/or expires_at; expiration is enforced without in-memory timers by evaluating indexed deadlines (verify_by, expires_at) via batch jobs, scheduled tasks, or DB TTL. Soft (query-time) expiry is treated as EXPIRED and subsequently hardened by batch. Query-time evaluation may also treat assets beyond policy windows as expired. This avoids per-asset timers.

Expiration may be enforced by periodic batch processing, scheduled tasks, or per-asset timers with TTL semantics; policy selects the mechanism per deployment.

Prior to issuance/activation, the system may maintain a reservation or mint-right with an expiry. Expiration is enforced by batch evaluation, scheduled tasks, or per-record TTL semantics, converting the reservation to EXPIRED absent a successful verification event within policy.

### 5. Security/Integrity Properties

The architecture removes activation authority from the issuance interface and confines the decisive state transition to an authenticated, durably audit-coupled server-side commit path, preventing activation via client-side session artifacts, purchase-edge race conditions, or uncontrolled replay. The improvement derives from the ordered combination of:
(a) Decoupled issuance/activation: The issuance interface can create only INACTIVE entitlements (or reservations) and cannot confer utility.
(b) Server-verified validation with bounded freshness: Acceptance requires one or more of: (i) stateless keyed recomputation over a time-windowed credential, (ii) token-rail evidence whose age at receipt is <=a policy freshness bound (using a trusted timestamp such as a relay receipt time or endpoint-signed event time with authenticated clock skew), or (iii) a server-maintained verification session with rolling nonces and server-side replay protection; all performed without reliance on a client purchase session. (Mode (i) is stateless with respect to per-credential storage; the system may still maintain operational state (e.g., rate/attempt counters) and may use a server-maintained verification session in mode (iii).)
(c) Trusted origins and provenance: Verification messages must originate from registered endpoints, authenticated relays with provenance, or authenticated clients under policy. For relayed messages, provenance is mapped to a registered origin before policy evaluation, and the relay identity and a provenance digest are captured in the durable audit.
(d) Durably-coupled activation (authoritative commit path): Activation is valid only if the audit artifact is written at the authoritative commit point and effectively-once semantics are enforced (via uniqueness keys and idempotent processing). The authoritative commit is realized either by a single ACID transaction (state change+insert-only audit in the same commit), or by an event-first activation ledger with a uniqueness key and idempotent materialization. In the ledger path, the ledger event constitutes the authoritative audit artifact; any audit table is a projection that references the ledger event identifier, and may be periodically anchored by a digest to provide tamper evidence.
(e) Access-control gating: Database and service roles deny the issuance path permission to set ACTIVE or create a utility artifact. Only the verification pathway may invoke sp_activate( . . . ), which enforces section 3.1 checks and records the audit in the same authoritative write path; only sp_activate( . . . ) may insert rows into Utility Artifact linked to an activation event.
(f) Replay and abuse controls: Uniqueness guards (e.g., (asset_id, request_id)), per-endpoint rate limits, and per-asset attempt thresholds limit brute force and replay; endpoints must supply unpredictable request identifiers, preferably cryptographically random with at least 128 bits of entropy.
(g) Scalable expiration: No in-memory timers are required. Expiration uses indexed deadlines (verify_by, expires_at) evaluated by batch jobs, scheduled tasks, or DB TTL; soft (query-time) expiry is treated as EXPIRED and hard-expired by batch thereafter.

Threat-model clarifications: Client origins may initiate verification but cannot set ACTIVE; only the server commit path can effect the state change. Session hijack risk is mitigated because activation requires server-verified evidence and a server-side commit with an authoritative audit artifact. A client origin may initiate verification; only the server-side authoritative commit path can effect INACTIVE->ACTIVE. Access-control gating is structural: database roles deny issuance-facing code the permission to write state=ACTIVE; only a stored procedure sp_activate (136), invoked by the verification service, holds the privilege to update the state and to write to the insert-only audit store within the same commit.

In an embodiment with saga-based durable coupling, issuance/activation follows a saga protocol that (A) appends an immutable audit artifact to a write-once store; (B) idempotently materializes the issuance/activation in a separate transaction; (C) enforces an application-level uniqueness key over the issuance target; and (D) runs a compensating action upon detection of any mismatch. Issuance/activation is invalid absent the audit artifact, and (A)-(D) enforce exactly-once semantics under concurrency. The saga pattern is an instance of the event-first ledger path, wherein the immutable audit artifact corresponds to the ledger append and compensating actions are emitted as subsequent ledger events.

In a production embodiment, security parameters may be calibrated to threat models: per-endpoint rate limits (e.g., 10-100 requests per minute for human-operated endpoints, 1000-10000 per hour for automated systems), per-asset attempt thresholds (e.g., 3-10 attempts before lockout), clock skew tolerances (e.g., ±30 seconds for network delays, ±5 seconds for synchronized systems), request_id entropy (minimum 128 bits via cryptographically secure random number generator), key rotation overlap windows (e.g., 1-24 hours allowing graceful transition), and freshness bounds (e.g., 30 seconds for real-time verification, 5 minutes for async flows). These ranges are illustrative; specific deployments adjust based on asset value, threat intelligence, and user experience requirements.

In an embodiment with extended threat considerations, insider misuse of verification endpoints is mitigated by endpoint identity, role-scoped keys, per-endpoint rate limits, and revocation; social-engineering risks at physical endpoints are reduced by trusted-origin requirements and policy whitelists. Cryptographic side-channels are mitigated via constant-time comparators and key-rotation; verification flooding is controlled by rate/attempt limits and endpoint-class caps. These measures are complementary; activation remains impossible without passage through the authoritative commit path.

### 6. Deployment Notes

Embodiments may use a stateless API layer for issuance and verification; a background worker service for batch expiration and archival; and a relational database with row-level security. Endpoint credentials and keys are rotated via the policy store 170. Indexed columns on state and timestamps support efficient evaluation.

### Section 6.1—Device Consistency Validation Independent of Wallet State

In certain embodiments, device consistency validation relies on the device fingerprint established during asset issuance rather than wallet pass registration data. This design choice provides several technical advantages:
(1) Temporal independence: Device binding precedes wallet provisioning, eliminating race conditions between wallet installation and verification attempts.
(2) Platform independence: The same device consistency algorithm applies whether the credential is rendered as a QR code, NFC payload, or wallet pass.
(3) Synchronization resilience: Device binding remains valid even if wallet pass synchronization fails, is delayed, or involves multiple user devices.
(4) Revocation simplicity: Wallet pass updates or removals do not affect the fundamental device binding, ensuring consistent security properties throughout the asset lifecycle.

The verification orchestrator compares device characteristics present in the verification request against the device fingerprint hash stored with the asset record, providing replay resistance that is independent of wallet platform behavior or cross-device pass synchronization.

Access-control gating is enforced by database roles: the issuance API role is denied UPDATE . . . SET state=′ACTIVE′ and may not invoke sp_activate( . . . ); only the verification role can call sp_activate( . . . ), which implements the validation checks of section 3.1 and writes the audit in the same commit.

### 6.2 Example Technical Workflows (Non-Limiting)

E-commerce embodiment. The system records an order-linked conditional entitlement with state INACTIVE and provisions an ephemeral credential to the buyer's device. Upon successful validation and policy checks, the verification orchestrator executes the authoritative commit path, writes the audit artifact, and: (a) if fulfillment is asynchronous, sets the entitlement state to ACTIVE_PENDING and triggers a fulfillment worker to create a distinct UtilityArtifact, after which the state transitions to ACTIVE; or (b) if fulfillment is immediate, sets the entitlement state directly to ACTIVE and (optionally) creates the Utility Artifact within the same commit path or an immediately subsequent task. In both cases, the credential remains a verification instrument; the shipped item is issued by a separate fulfillment pipeline keyed to the asset identifier. An order state machine (e.g., PAID->HUMAN_VERIFICATION_PENDING->VERIFIED->PROCESSING) may advance in response to the activation event identifier.

In a ticketing embodiment, the credential may represent a conditional entitlement rather than the final ticket. After authenticated activation, the ticketing service issues or provisions a separate ticket artifact to the account. The system maintains independent lifecycles for the entitlement (verification-gated) and the ticket (event-gated), with the activation event acting as the substitution point recorded in the durable audit store (insert-only). Fulfillment may be asynchronous and causally triggered by the activation event (outbox/queue); the activation commit completes before fulfillment begins.

In an account-gating embodiment, the service stores an INACTIVE capability flag associated with a user account. The user obtains a credential linked to the flag and presents it at an authenticated endpoint operated by a trusted party. On successful validation, a single transaction sets the capability flag to ACTIVE and records the change in the durable audit store. Login or session state alone is insufficient to set the flag; only the audited activation event can perform the change, ensuring that access is enabled exclusively by authenticated real-world verification.

In certain embodiments, an activation plan specifies verification requirements for an entitlement. A plan comprises steps; each step declares a trusted origin type, evidence types, a freshness bound, and optional ordering or dwell-time constraints. Plans may require M of N steps, ordered or unordered, with deadlines. The verification orchestrator records completion events and evaluates plan satisfaction; activation occurs only upon plan satisfaction.

In certain embodiments, an external authority origin may assert an in-person transaction result including terminal identifier, merchant/venue identifier, and a transaction timestamp; the integration service attaches provenance metadata and signs the message; the verification service enforces DELTA_POLICY and optionally endpoint/venue whitelists before activation.

Ticketing POP (anti-bot) via payment-rail evidence. The purchaser receives an INACTIVE entitlement. The system or an issuer-processor provisions a device-bound payment instrument to the purchaser's mobile wallet and binds a pseudonymous instrument identifier to the entitlement record. A later card-present POS authorization using that instrument (optionally at a whitelisted terminal) produces normalized authorization data conforming to the card-present (or “payment-instrument-present) profile, e.g. POS entry mode (ISO 8583 Data Element 22) values indicating device present. (Policy may require various ISO 8583 fields according to implementation needs. The foregoing message fields are illustrative; any schema that conveys equivalent context may be used.) The integration service attaches provenance and signs; the verification service enforces freshness, maps terminal/merchant to policy, and performs the durably-coupled activation. Ticket minting and/or issuance may remain deferred until a release_not_before time. The POS transaction acts as an orthogonal control input to the entitlement and need not involve the payment instrument that funded the purchase.

Age-gating via payment-rail evidence: a purchaser's entitlement remains INACTIVE until a POS authorization at an age-restricted merchant category or venue class or merchant list (per policy mapping from normalized authorization data) is received from an authenticated integration service with provenance; upon validation and freshness checks, the account or feature flag is set ACTIVE by the durably-coupled path. The device-bound instrument used as the verification signal may be provisioned after the order is recorded and need not be the instrument that funded the order (nor is any traditional payment-associated ‘order’ required); the binding is effected by associating the issuer- or wallet-scoped instrument token with the entitlement record.

### 6.3 Text-Only Embodiments (Drawable Specifications)

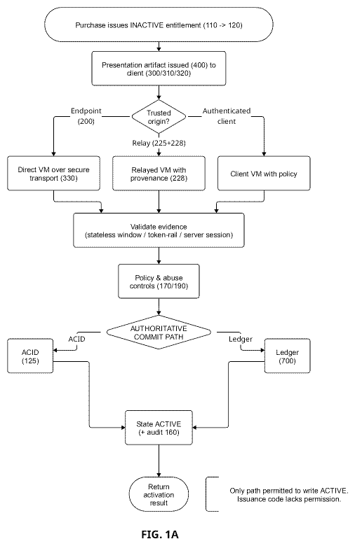

Embodiment A: Asset State Machine (flowchart). A finite-state machine governs asset records with states comprising INACTIVE, ACTIVE_PENDING, ACTIVE, EXPIRED, REDEEMED, and REVOKED. The only permitted transition to ACTIVE occurs via Verification Orchestrator 140 executing the authoritative commit path-either single-transaction ACID 125 or append—only ledger 700—upon policy-conforming validation; guards require prior state=INACTIVE, uniqueness key satisfaction, and durable audit 160 written. Valid transitions (exhaustive): INACTIVE->ACTIVE (authoritative path); INACTIVE->ACTIVE_PENDING (authoritative path, when policy requires deferred fulfillment) (see FIG. 6 “per policy” callout); INACTIVE->EXPIRED (batch/scheduled/DB-TTL evaluation of verify_by/expires_at); ACTIVE_PENDING->ACTIVE (fulfillment completion by worker 610 with Utility Artifact 620 creation; idempotent audit); ACTIVE_PENDING->EXPIRED (policy deadline elapsed); ACTIVE->REDEEMED (on use/consumption; VO 140 or idempotent consumer 710 records redemption and audit 160); ACTIVE->REVOKED (administrative/security action per policy; audit 160 required); ACTIVE->EXPIRED (policy time elapses post-activation). Terminal states: EXPIRED, REDEEMED, REVOKED (no outgoing edges). Only stored procedure 136 or a ledger consumer may change state; issuance-facing code cannot set ACTIVE (see FIG. 1A trust-boundary callout).
Embodiment B: Data Model (ER diagram with cardinalities/constraints). Entities: Asset (asset_id PK, state, created_at, verify_by?, expires_at?, activation policy, binding_data_hash?, history_ref?, presentation_artifact_ref?); Policy (policy_id PK, endpoint_class, location_class?, DELTA_POLICY, tolerances); KeyRegistry (KID PK, alg, status, rotation_window); ProcessedVerifications (asset_id FK->Asset, request_id, UNIQUE (asset_id, request_id)); AuditLog (audit_id PK, asset_id FK, event_type, ts, provenance_digest)-insert-only/WORM; ActivationLedger (event_id PK, asset_id FK, request_id, ts, payload_digest)-append-only, UNIQUE (asset_id, request_id); RateAttempt (counter_id PK, key, window, count, TTL); PresentationArtifact (artifact_id PK, asset_id FK, artifact_type, status, activation_event_id?, linked_artifact_id?, last_seen_at); Utility Artifact (artifact_id PK, asset_id FK, type, status). Relationships: Asset 1->0 . . . * PresentationArtifact; Asset 1->0 . . . 1 UtilityArtifact; Asset 1->0 . . . * AuditLog; Asset 1->0 . . . * ActivationLedger (AuditLog rows may reference ledger event_id); Policy 1->0 . . . * Endpoint registrations (each Endpoint 1->1 Policy); Asset 1->0 . . . * ProcessedVerifications (UNIQUE per request_id). Indexes: state, verify_by, expires_at for expiry scans; AuditLog enforced insert-only; ActivationLedger enforced append-only with optional digest anchoring.
Embodiment C: Direct Verification Sequence (UML sequence). Client 300 presents presentation artifact 400 (QR/NFC or tokenized identifier 420) to endpoint 200. Endpoint constructs verification message 500 containing fields 510-570 (and, as applicable, 575/580/585/590) per policy and transmits via secure transport 330 (e.g., mutual TLS) to Verification Orchestrator 140. The orchestrator authenticates origin 510; validates evidence via one or more of: stateless window validation, token-rail freshness, or server session validation; applies policy and abuse checks against 170/190; optionally inserts (asset_id, request_id) into 180. The authoritative commit executes as in FIG. 6: either a single ACID commit that updates 120 and inserts 160, or a 705 ledger append followed by idempotent projector 710. System returns activation result and updates PresentationArtifact record 430 per policy.
Embodiment D: Relayed Verification with Provenance (UML sequence). Credential-accepting endpoint 215 emits evidence and endpoint_id to Integration Service 225, which attaches provenance 228 including relay identity 580, relay nonce/sequence 585, relay receipt time, mapped origin 555, and optional attestation reference 575. The relay transmits via authenticated transport to VO 140, which authenticates the relay against key registry 175R and maps provenance to a registered origin before policy evaluation. Validation/policy checks proceed as in Embodiment C; commit per FIG. 6. Audit records relay identity and a provenance digest in 160, or references event_id if using the ledger path.
Embodiment E: Stateless Time-Windowed Credential Validation (flowchart). Compute window_id=floor((server_time+skew)/DELTA_WINDOW). Recompute H=HMAC (K[KID], serialize(version, asset_id, window_id, policy_tag, KID)) using deterministic serialization. Accept only if tag matches and |received_window_id-current_window_id|≤tolerance. Reject future windows (current+1) by default. Boundary grace g≤5 s permitted only with mutually-authenticated transport and message signature/MAC bound to endpoint identity. Use constant-time comparison; log failures for abuse controls.
Embodiment F: Expiration Mechanisms (flowchart). Soft expiry treats out-of-window assets as EXPIRED at query time with later hardening by batch. Hard expiry scans indexed verify_by/expires_at by batch/scheduled/TTL evaluation, sets EXPIRED, and writes audit. No per-asset timers; optional per-record TTL supported by the database.
Embodiment G: Device Binding (UML sequence). Fingerprint-HMAC variant: issuance captures minimal device attributes and computes binding_data_hash=HMAC (server_key, attributes∥per_record_salt) stored on the Asset. Credential 400 is provisioned to wallet app 310 or secure element 320. During verification, VO compares request device signals to the stored hash under policy. Secure-element variant: associate a pseudonymous instrument token with the Asset; later card-present use yields normalized authorization data via 225; VO enforces freshness/policy before activation via the authoritative path.
Embodiment H: Policy Model (UML class diagram). Policy contains exactly one FreshnessPolicy and one AttemptThreshold, and zero or more RateLimit entries. Each Endpoint references exactly one Policy and may be classified by LocationClass. IntegrationService maps to zero or more Endpoints via Provenance rules (zero or more entries defining allowed origins, key material, and skew tolerance). ActivationPlan (optionally per asset class) comprises one or more steps; each binds an evidence type, a freshness bound, and optional ordering or dwell constraints. Policy store 170 maintains these entities; VO 140 queries policy before commit.
Embodiment I: Post-Activation Fulfillment (UML sequence). After the commit path returns an event identifier (ACID commit ref or ledger event_id), fulfillment worker 610 creates a Utility Artifact causally linked to the event and updates the Asset from ACTIVE_PENDING to ACTIVE, or directly to ACTIVE per policy. The audit records the activation/fulfillment association; retries are idempotent and return the same artifact identifier.
Embodiment J: Activation Plan Schema and Evaluation (class diagram+flowchart). ActivationPlan: {plan_id, M, N, ordered?, dwell?, deadline?}. PlanStep: {step_id, origin_type, evidence_profile, freshness_bound, order_index?}. CompletionEvent: {step_id, ts, provenance_digest}. Evaluation: collect events->enforce M-of-N and ordering/dwell->if satisfied, invoke authoritative commit path; else record attempt and enforce thresholds/rate limits.
Embodiment K: External-Authority Origin (UML sequence). Client 300->POS 210->Network->Integration Service 225 (+228)->VO 140->commit path. Evidence includes normalized authorization data with an in-person indicator and at least one of terminal or merchant identifiers; accept only if a trusted timestamp satisfies server_time-trusted_event_time≤DELTA_POLICY. Policy enforces whitelist mapping; activation per FIG. 6 (ACID or ledger).
Embodiment L: Access-Control Gating (class/privilege diagram). IssuanceRole: DENY UPDATE state=‘ACTIVE’; DENY INSERT into Audit 160; cannot invoke stored procedure 136. VerifyRole: ALLOW invoking 136; ALLOW ledger append/consumer operations. State Store 120 is read/write (controlled by 136); Audit 160 is insert-only/WORM; Activation Ledger 705 is append-only. Only the authoritative path (stored procedure 136 or ledger consumer) can confer utility, matching FIG. 1A's “issuance code lacks permission” callout.
Embodiment M: Threat Model & Replay Controls (attack tree). Root: “Unauthorized or duplicated activation.” Child attacks: Replay (duplicate 500), Flooding/DoS (exhaust rates/attempts), Relay impersonation (fake 225), Endpoint mis-mapping (wrong origin policy), Races (double activation). Mitigations (attach with “mitigated-by” edges): Replay->Uniqueness guard 180, idempotent ledger 705/consumer 710, constant-time compare, Audit 160; Flooding->Rate limits/Attempt thresholds 190+endpoint-class caps in 170; Relay impersonation->mutual auth with 175R, required provenance 228, audited 580; Endpoint mis-mapping->provenance->registered-origin mapping (reject on mismatch; audit mismatch); Races->single ACID commit 125 or unique ledger append 705. Legend: solid arrows=attack; dashed=mitigation (“mitigated-by”).

### 7. Terminology

An “integration service” is a trusted relay that delivers authenticated verification messages observed at credential-accepting endpoints.

Insert-only (audit store): a data structure that forbids updates and deletes (e.g., WORM or row-immutability via constraints/RLS) used to record audit entries.

Asset; reservation; utility artifact. An “asset” includes (i) a conditional entitlement or mint-right recorded prior to verification, and/or (ii) a utility artifact created upon verification (e.g., a ticket or capability, including access or account or feature unlock). A “reservation” or “mint-right” is a record that confers the ability to obtain the utility artifact upon successful verification but is not itself the utility artifact.

The naming conventions of data elements are meant to be illustrative and not limiting.

The naming conventions of states of asset records (e.g. INACTIVE->ACTIVE, etc.) is meant to be illustrative and not limiting. For example, the names could be adapted to specific use cases, and such terms and transitions as “PENDING”-> “VERIFIED” or “ACTIVE”-> “REDEEMED” or “NON-FUNCTIONAL”-> “FUNCTIONAL” or any other appropriate names and transition sequences may be substituted without departure from the disclosure.

Authorization artifact: data generated responsive to credential presentation at a credential-accepting endpoint, comprising a nonce or approval reference usable to enforce a freshness constraint

Freshness constraint: a policy-defined maximum age or bounded time window for considering an authorization artifact valid.

Endpoint class: a policy-assigned category identifying capabilities or location of a verification endpoint.

Tokenized identifier: an identifier produced by provisioning the credential to a device-resident secure component or wallet, presented at a credential-accepting endpoint and verifiable by association with the asset record.

Provenance metadata: metadata accompanying or embedded in a verification message that is sufficient to identify an originating verification endpoint and establish chain-of-custody for a relayed event, including any combination of endpoint identifiers, endpoint class or location indicators, device certificate fingerprints or attestation references, relay timestamps or sequence identifiers, and digests or references to presented credentials or authorization artifacts.

Integration service authentication: any mechanism by which the verification orchestrator authenticates a relay that delivers verification messages, including but not limited to mutually authenticated and encrypted transport, message signatures or MACs verified with registered keys, signed tokens bound to relay key identifiers, or endpoint-scoped API credentials over authenticated transport. Authentication may be performed prior to or as part of credential validation.

Authenticated verification endpoint: an authorization-scoped endpoint distinct from the issuance interface (physically or logically separate) that is authenticated by bearer credentials and/or by an authenticated, encrypted transport bound to an endpoint identity.

Issuer-processor integration: an authenticated integration service that relays normalized authorization data with provenance and freshness on behalf of a payment or identity network; such external authority origin is accepted as a trusted origin under policy.

DELTA_WINDOW: credential time-window width used to compute window_id.

DELTA_POLICY: evidence freshness bound configured in the policy store.

Device-bound payment instrument: a mobile-wallet provisioned instrument whose use is restricted by the wallet secure element to a single device; identified to the system by a pseudonymous instrument identifier associated with an entitlement.

“Normalized authorization data” means any structured event record from an external authority that, regardless of format or field naming, conveys: (i) binding evidence linking the event to an entitlement holder, (ii) temporal evidence sufficient to enforce freshness constraints, and (iii) contextual evidence sufficient to enforce policy controls. The verification service evaluates whether the totality of evidence satisfies the security invariant: proof of holder possession/presence decoupled from the purchase session, with freshness-bounded validation. Field mappings and evidence sufficiency are determined by the verification service according to security policy, not by the external authority's schema. Provider-specific fields may be mapped to this minimal schema; additional fields may be present.

Atomic; ACID. “Atomic” refers to an all-or-nothing commit performed by a transaction manager; either all writes (state update, audit append, and any optional uniqueness insert) persist, or none persist. “ACID semantics” refers to atomicity, consistency, isolation, and durability as provided by transactional systems.

Exactly-once (as used herein) means effectively-once behavior achieved via uniqueness keys on the authoritative commit (or ledger append) and idempotent processing under concurrency and retry.

Append-only. “Append-only” is realized by a write-once object store or by a database table with insert-only policy and row immutability enforced by constraints or storage tier.

Provenance mapping. For relayed events, provenance metadata is mapped to a registered originating endpoint prior to policy evaluation; failures in authentication or mapping cause rejection and are recorded with relay identity in the durable audit store.

Trusted origin. A “trusted origin” for verification includes a registered verification endpoint, an authenticated integration service relaying an event from a registered originating endpoint with provenance, or an authenticated end-user device operating under a verification policy.

Trusted timestamp: a time value authenticated by the system, e.g. a relay-signed receipt time or an endpoint-signed event time verified under the endpoint's registered key and acceptable skew.

Authoritative commit path: a constrained write path that either (i) performs a single atomic transaction that conditionally updates asset state and appends an entry to an insert-only audit store, or (ii) appends an event to an append-only activation ledger under a uniqueness key, where only idempotent consumers may materialize state and audit.

release_not_before (T_r): a policy time not earlier than which a Utility Artifact may be issued or become usable, independent of the time at which activation is validated.

Module/Service: as used herein, a service or process executed by one or more processors from non-transitory memory; the term is not intended to invoke 35 U.S.C. § 112 (f) unless expressly recited as “means for”.

Authenticated general-purpose client. A trusted origin for verification further includes an authenticated general-purpose client that satisfies policy-defined assurance (e.g., identity authentication, device integrity attestation, and freshness-bounded challenge completion) without prior endpoint registration. The verification service accepts such origin as sufficient to trigger activation or issuance when policy is met.

External authority origin. A trusted origin may comprise an external identity or transaction network that asserts a transaction-bound authentication result, delivered via an authenticated integration service with provenance and freshness. Such results are accepted as sufficient evidence under policy.

In-person indicator: a field within standardized transaction messages (e.g., card-present/entry-mode indicators in ISO 8583 or successor specifications) that evidences in-person use of a payment instrument at a physical terminal.

Tokenized identifier here denotes a device/wallet-scoped pseudonymous identifier bound to the asset; it is distinct from payment-network PAN tokens unless explicitly stated.

Activation ledger; idempotent materialization. An “activation ledger” (outbox/event log) is an append-only log of activation events under a uniqueness key; “idempotent materialization” is consumer processing that deterministically creates or updates state and audit exactly once per ledger event.

Presentation artifact; utility artifact. A “presentation artifact” is a device-resident artifact associated with an entitlement for initiating verification. A “utility artifact” is the usable ticket/capability created or enabled upon activation.

No session reliance. Validation does not rely on server-maintained purchase session state; authenticity and presence are established by server-verified evidence with bounded freshness.

A “client purchase session” means any client-side session state, token, or identifier established during the commerce transaction that recorded the INACTIVE asset; validation does not rely on such session state.

Durably-coupled activation means either (A) a single atomic transaction that (i) conditionally updates the asset state and (ii) appends an entry to an insert-only durable audit store within the same commit, or (B) appending an activation event to an append-only activation ledger under a uniqueness key, where only idempotent consumers of that ledger are authorized to (i) update the asset state or (ii) create a distinct utility artifact, in causal association with the ledger event. The audit store and ledger forbid updates and deletes; the ledger may be periodically anchored by a digest to provide tamper evidence.

Stateless credential validation refers to mode (i), which uses no per-credential server storage; the system may still maintain operational state (e.g., rate/attempt counters) and may use a server-maintained verification session in mode (iii).

### 8. Conclusion

The disclosed architecture implements a non-conventional ordered combination that hardens activation by removing activation authority from the issuance interface and confining the decisive state change to an authenticated, durably audit-coupled commit path realized by either a single ACID commit or an event-first activation ledger with idempotent materialization. Validation uses server-verified evidence by at least one of: stateless keyed recomputation, token-rail artifact freshness, or a server-maintained verification session; access-control gating prevents any other code path from conferring utility.

Unlike conventional flows that grant utility at purchase time or based on client-side heuristics, the decisive state change is moved off the user-facing interface and bound to an authenticated, auditable server-side operation. This arrangement sidesteps the client-side attack surface and prevents activation via session artifacts, replay within uncontrolled windows, or partial commits. Optional replay de-duplication, endpoint-class/location policy, per-endpoint rate limits, per-asset attempt thresholds, and timer-free batch expiration further constrain abuse without introducing per-asset timers or session state.

The improvement derives from the interlocking arrangement of these elements-decoupled issuance, authenticated verification origination, stateless or freshness-based validation, and atomic state-plus-audit—not from any single technique alone. The result is a computer-security improvement to digital-asset lifecycle control: only an authenticated, audited activation event can confer utility, and any other pathway is insufficient under policy to effect the INACTIVE->ACTIVE transition.

While the invention has been described in connection with what is presently considered to be the most practical and preferred embodiments, it is to be understood that the invention is not to be limited to the disclosed embodiments, but, on the contrary, is intended to cover various modifications and equivalent arrangements within the spirit and scope of the appended claims.

What is claimed is:

1. A computer-implemented method for secure activation of a digital entitlement, comprising:
(a) storing, in an asset state store, an asset record comprising a unique identifier and a state set to INACTIVE;
(b) receiving, from a trusted origin comprising at least one of (i) a registered verification endpoint, (ii) an authenticated integration service relaying an event from a registered originating endpoint with provenance, or (iii) an authenticated client operating under a verification policy, a verification message comprising the asset identifier, origin metadata, and freshness-bounded evidence;
(c) validating the verification message without reliance on a client purchase session by confirming origin authenticity and confirming holder possession or presence using at least one of:
(1) stateless recomputation, using server-held key material selected by a key identifier, of a keyed authentication value over a credential payload that includes the asset identifier and a time-window identifier, and accepting only if the recomputed value matches and the time window is within a policy tolerance; or
(2) verifying that normalized authorization data produced by presentation of a tokenized identifier maps to a registered association for the asset record and that a trusted_event_time satisfies server_time-trusted_event_time≤DELTA_POLICY;
(d) activating the asset record only by an authoritative commit path that enforces (i) no activation absent a durable audit artifact and (ii) exactly-once activation under concurrency, the authoritative commit path comprising one of:
(1) executing, by a transaction manager, a single atomic transaction that conditionally updates the state from INACTIVE to ACTIVE and, in the same commit, appends an entry to an insert-only durable audit store; or
(2) appending an activation event with a uniqueness key to an append-only activation ledger and idempotently materializing a state change to ACTIVE while writing the durable audit; and
(e) enforcing access-control gating that prevents any code path other than the authoritative commit path from writing the state value ACTIVE for the asset record.

2. The method of claim 1, wherein the insertion or append in step (d) further records a provenance digest and an identity of any relay that delivered the verification message.

3. The method of claim 1, wherein the durable audit store forbids updates and deletes and entries are periodically anchored by a digest.

4. The method of claim 1, wherein step (d)(1) further comprises inserting (asset_id, request_id) into a uniqueness-constrained table within the same transaction, and refraining from any state change upon conflict.

5. The method of claim 1, wherein the activation ledger enforces uniqueness on (asset_id, request_id) and only idempotent consumers are authorized to write activation results to the state store.

6. The method of claim 1, wherein validation in step (c)(1) rejects future windows (current+1) by default and permits a boundary grace g≤5 s only when the transport is mutually authenticated and the message carries a signature or MAC bound to the endpoint identity.

7. The method of claim 1, further comprising transitioning non-activated assets to EXPIRED by batch or schedule evaluation of verify_by or expires_at without per-asset timers.

8. The method of claim 1, wherein a PresentationArtifact status is updated to CONSUMED upon activation and, when substitution occurs, a linked UtilityArtifact identifier is recorded.

9. A computer-implemented method comprising:
(a) storing, in a database, a record associated with an INACTIVE entitlement;
(b) receiving, via an authenticated integration service with provenance, normalized payment authorization data comprising an in-person indicator and at least one of a terminal identifier, a merchant identifier, or a merchant category code;
(c) validating without reliance on a client purchase session by confirming relay authentication, mapping the terminal or merchant identifiers to a policy whitelist, and accepting only if a trusted_event_time satisfies server_time-trusted_event_time≤DELTA_POLICY; and
(d) activating the entitlement only by an authoritative commit path that enforces (i) no activation absent a durable audit artifact and (ii) exactly-once activation under concurrency, the authoritative commit path comprising one of:
(1) a single atomic transaction that conditionally updates the entitlement state from INACTIVE to ACTIVE and, in the same commit, appends an entry to an insert-only durable audit store; or
(2) appending an activation event under a uniqueness key to an append-only activation ledger and idempotently materializing a state change to ACTIVE while writing the durable audit; and
(e) enforcing access-control gating that prevents any code path other than the authoritative commit path from writing the state value ACTIVE.

10. The method of claim 9, wherein the authorization data references a device-bound instrument token that is associated with the entitlement record.

11. The method of claim 9, wherein the whitelist corresponds to age-restricted merchant categories or venue classes and activation sets an account capability flag.

12. The method of claim 9, further comprising limiting activations by permitting at most one activation per instrument token across an asset class during a policy window.

13. The method of claim 9, further comprising recording a hash of the terminal identifier and the merchant category code in the durable audit.

14. A computer-implemented method comprising:
(a) recording, in a database, a reservation associated with an item selection, the reservation not comprising a usable digital asset;
(b) receiving, from a trusted origin comprising at least one of (i) a registered verification endpoint, (ii) an authenticated integration service relaying an event from a registered originating endpoint with provenance, or (iii) an authenticated client operating under a verification policy, a verification message comprising the reservation identifier and freshness-bounded evidence;
(c) validating the verification message without reliance on a client purchase session by confirming origin authenticity and confirming holder possession or presence using at least one of:
(1) stateless recomputation, using server-held key material selected by a key identifier, of a keyed authentication value over a credential payload that includes the reservation identifier and a time-window identifier, and accepting only if the recomputed value matches and the time window is within a policy tolerance; or
(2) verifying that normalized authorization data produced by presentation of a tokenized identifier maps to a registered association for the reservation and that a trusted_event_time satisfies server_time-trusted_event_time≤DELTA_POLICY;
(d) performing a durably-coupled issuance that enforces (i) no issuance absent a durable audit artifact and (ii) exactly-once issuance under concurrency, by either:
(1) executing a single atomic transaction that creates, for a first time, a digital asset associated with the reservation under a uniqueness constraint keyed to the reservation and, in the same commit, appends an entry to an insert-only audit store; or
(2) appending an issuance event with a uniqueness key to an append-only ledger and idempotently materializing creation of the digital asset while writing the durable audit; and
(e) enforcing access controls preventing any code path other than step (d) from creating the digital asset.

15. The method of claim 14, wherein retries return the prior issuance result without duplicating assets.

16. The method of claim 14, further comprising reservation expiry by batch, schedule, or TTL if validation is not completed by verify_by.

17. The method of claim 14, wherein post-issuance fulfillment is asynchronous and causally tied to the issuance event identifier.

18. A computer-implemented method comprising:
(a) storing, in an asset state store, an asset record comprising a unique identifier and a state set to INACTIVE;
(b) receiving, from a trusted origin comprising at least one of a registered verification endpoint, an authenticated integration service with provenance, or an authenticated client operating under a verification policy, a verification message comprising the asset identifier and freshness-bounded evidence;
(c) validating without reliance on a client purchase session by correlating a server-maintained verification session comprising a server-issued challenge and one or more step-up responses under rolling nonces and server-side replay protection, and accepting only if session age≤DELTA_POLICY;
(d) activating the asset only by an authoritative commit path that enforces (i) no activation absent a durable audit artifact and (ii) exactly-once activation under concurrency, by either (1) a single atomic transaction that conditionally updates state and, in the same commit, appends an entry to an insert-only durable audit store, or (2) appending an activation event under a uniqueness key to an append-only activation ledger and idempotently materializing a state change to ACTIVE while writing the durable audit; and
(e) enforcing access-control gating that prevents any code path other than the authoritative commit path from writing the state value ACTIVE.

19. The method of claim 18, wherein the step-up responses comprise a WebAuthn assertion or a platform integrity attestation verified under registered keys.

20. The method of claim 18, further comprising binding the session to an endpoint class or location class per policy.

21. A computerized system comprising one or more processors and non-transitory memory storing instructions that, when executed, cause the system to:
(a) maintain an asset state store that stores asset records each having an identifier and a state initially set to INACTIVE;
(b) maintain a durable audit store that forbids updates and deletes;
(c) receive, from a trusted origin, a verification message comprising the asset identifier, origin metadata, a request identifier, and freshness-bounded evidence;
(d) validate the verification message without reliance on a client purchase session using at least one of: stateless recomputation of a keyed authentication value over a time-windowed payload selected by a key identifier, or verification that normalized authorization data maps to a registered association within a policy freshness bound; and
(e) activate the asset record only by executing, via a transaction manager, a single atomic transaction that (i) conditionally updates the state from INACTIVE to ACTIVE only if the prior state equals INACTIVE and (ii) in the same commit appends an entry to the insert-only durable audit store, while enforcing access-control gating that denies issuance-facing code permission to set the state to ACTIVE or to write to the durable audit store.

22. The system of claim 21, wherein only a stored procedure is authorized to update the state and to append to the insert-only audit store in the same commit.

23. The system of claim 21, further comprising a presentation-artifact store recording artifact status and a link to any created utility artifact.

24. The system of claim 21, further comprising a rate/attempt store maintaining counters keyed by endpoint identifier and asset identifier with TTL.

25. A non-transitory computer-readable medium storing instructions that, when executed by one or more processors, cause performance of the method of claim 1.

26. A computerized system for secure activation of digital entitlements, comprising:
(a) an asset state store that stores asset records with states including INACTIVE and ACTIVE;
(b) an append-only activation ledger that enforces uniqueness on a key comprising the asset identifier and a request identifier;
(c) an idempotent materialization component coupled to the activation ledger and authorized to update the asset state store and to write audit records only in causal association with a ledger event;
(d) a durable audit store that records activation outcomes and references the ledger event identifier;
(e) a verification orchestrator configured to receive verification messages from trusted origins with freshness-bounded evidence and to validate the messages without reliance on a client purchase session using at least one of stateless keyed-window validation or token-rail freshness validation; and
(f) access-control constraints that deny non-verification code paths permission to set the state to ACTIVE,
wherein the system enforces effective-once activation under concurrency by permitting only idempotent consumers of the activation ledger to materialize a change of state from INACTIVE to ACTIVE and to record the audit.
